(19) United States
(12) Patent Application Publication
(10) Pub. No.: US 2015/0359385 A1
(43) Pub. Date: Dec. 17, 2015

(54) GRILL AND SMOKER CONVERTIBLE CONFIGURATION DEVICE AND METHOD

(71) Applicant: Robert Suchevits, Cheswick, PA (US)

(72) Inventor: Robert Suchevits, Cheswick, PA (US)

(21) Appl. No.: 14/302,072

(22) Filed: Jun. 11, 2014

(51) Int. Cl. A47J 37/07; B23P 19/00; A23B 4/052

(52) U.S. Cl. CPC A47J 37/0786; A23B 4/052; B23P 19/00

(57) ABSTRACT

A grill converter device may include a plurality of cover sections. Each cover section may be removably connected to each other cover section by a plurality of fasteners. At least one airflow regulator hole may be positioned along a side of at least one of the plurality of cover sections. At least one airflow regulator cover may removably cover the at least one airflow regulator hole. When adding a smoke box on a grill, the grill converter device allows for control over the smoking process. The conversion may allow for a controlled adjustment of the smoke inside a lid of a grill.

### BACKGROUND OF THE INVENTION

The present invention relates to grills and smokers and, more particularly, to a grill and smoker convertible configuration device and method.

Currently, smokers for a bar-b-que are expensive, labor intensive and quite large. Many people enjoy smoked foods and sauces, but cannot afford or do not have the extra space for a full-size smoker. A smoke box alone on a grill does not allow you to smoke your item at a controlled temperature or have a containment of the smoke. Instead, any smoke that is created is quickly exhausted from the grill. Gas usage is high to keep at an optimal smoking temperature.

As can be seen, there is a need for a grill and smoker convertible configuration device and method that allows the grill to burn at a low setting on a smoke box and containing the smoke at an optimal temperature increasing the smoking at a lower gas cost.

### SUMMARY OF THE INVENTION

In one aspect of the present invention, a grill converter device comprises: a plurality of cover sections, wherein each cover section is removably connected to each other cover section by a plurality of fasteners; at least one airflow regulator hole positioned along a side of at least one of the plurality of cover sections; and at least one airflow regulator cover, wherein the at least one airflow regulator hole is removably covered by the at least one airflow regulator cover.

In another aspect of the present invention, a method for converting a grill to a smoker configuration comprises: placing a grill converter device on a lid of the grill, wherein the grill converter device comprises a plurality of cover sections, wherein each cover section is removably connected to each other cover section by a plurality of fasteners; at least one airflow regulator hole positioned along a side of at least one of the plurality of cover sections; and at least one airflow regulator cover, wherein the at least one airflow regulator hole is removably covered by the at least one airflow regulator cover; tightening all fasteners to secure the grill converter device to the lid; placing a smoke box directly over an open flame set on a lowest setting; and adjusting the airflow regulator cover in conjunction with a burner control temperature as needed.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention;

FIG. 3 is an exploded view of an exemplary embodiment of the present invention;

FIG. 4 is a section view of an exemplary embodiment of the present invention, taken along line 4-4 in FIG. 1; and

FIG. 5 is a section view of an exemplary embodiment of the present invention, illustrating the movement.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a grill converter device that may include a plurality of cover sections. Each cover section may be removably connected to each other cover section by a plurality of fasteners. At least one airflow regulator hole may be positioned along a side of at least one of the plurality of cover sections. At least one airflow regulator cover may removably cover the at least one airflow regulator hole. When adding a smoke box on a grill, the grill converter device allows for control over the smoking process. The conversion may allow for a controlled adjustment of the smoke inside a lid of a grill.

The present invention may convert a backyard grill into a low-cost smoker with components that you can fold down into something that may fit into a drawer or the like for storage. The device may control the temperature and contain the desired amount of smoke that the grill creates by utilizing the inherent insulation of fireproof/fire-retardant materials therein. The present invention may lower the cost of smoking food on a grill and eliminate the purchase of a big, bulky smoker. The present invention may wrap itself around a grill lid, but still allow the user to check the food because it may not interfere with the motion of the lid itself.

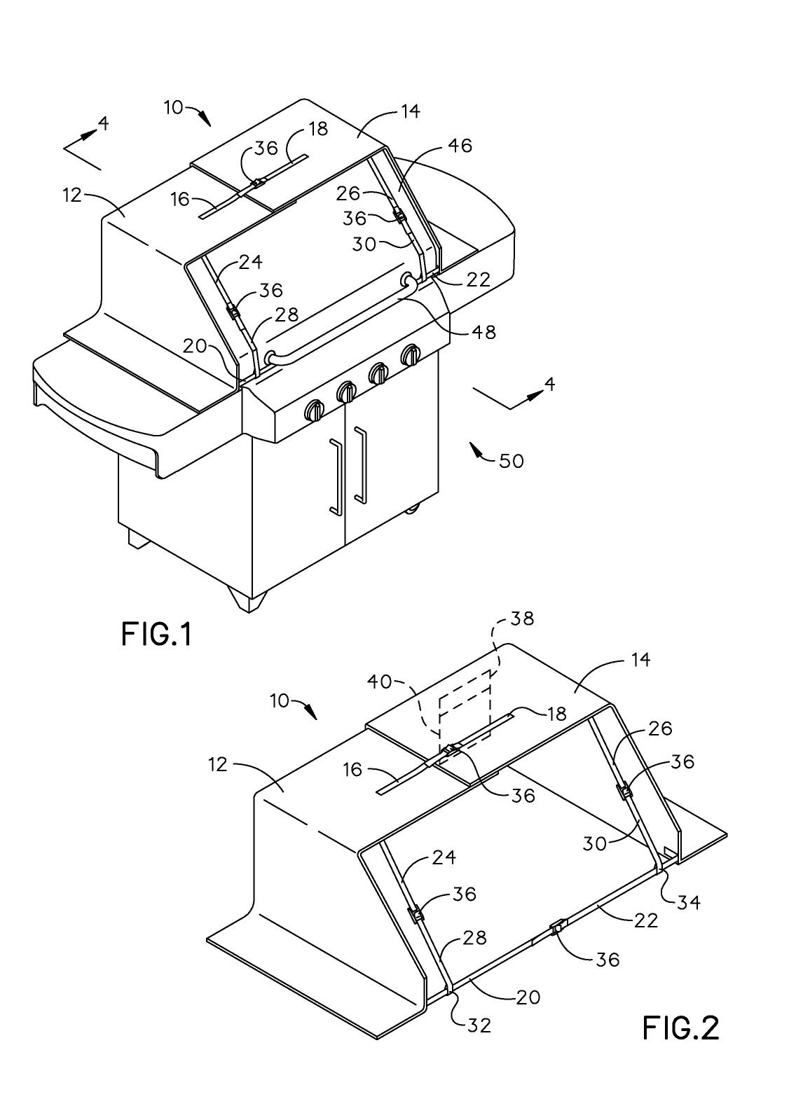

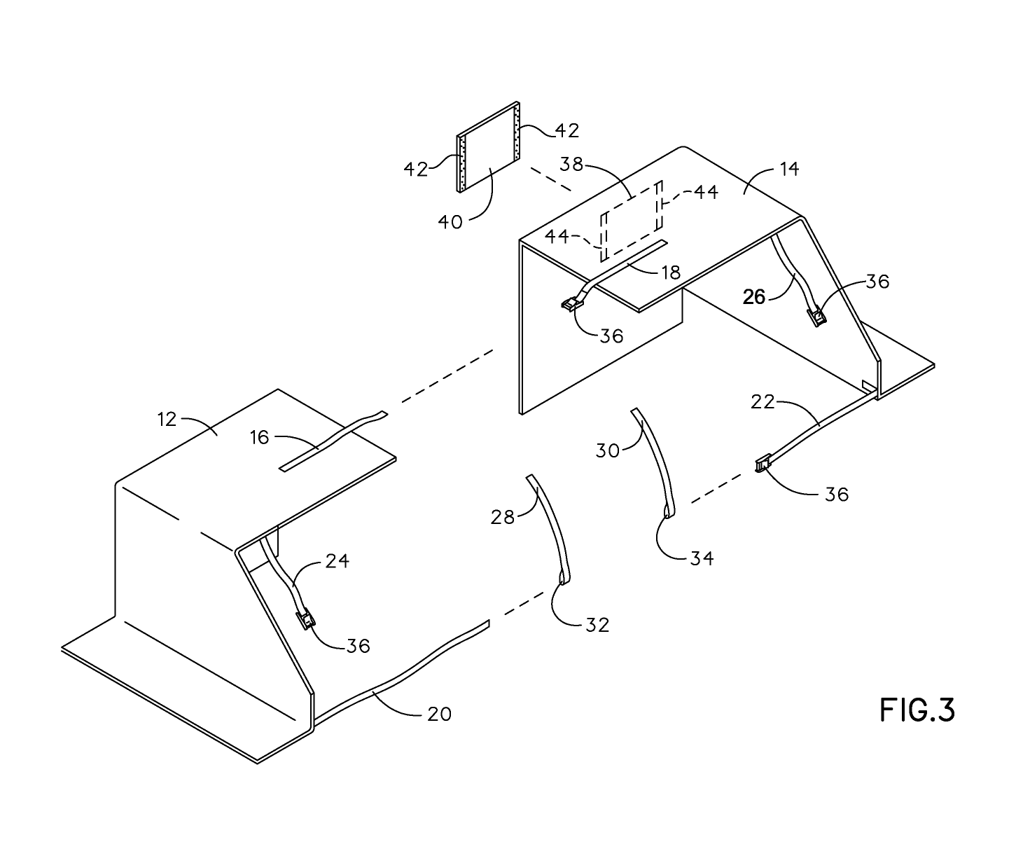

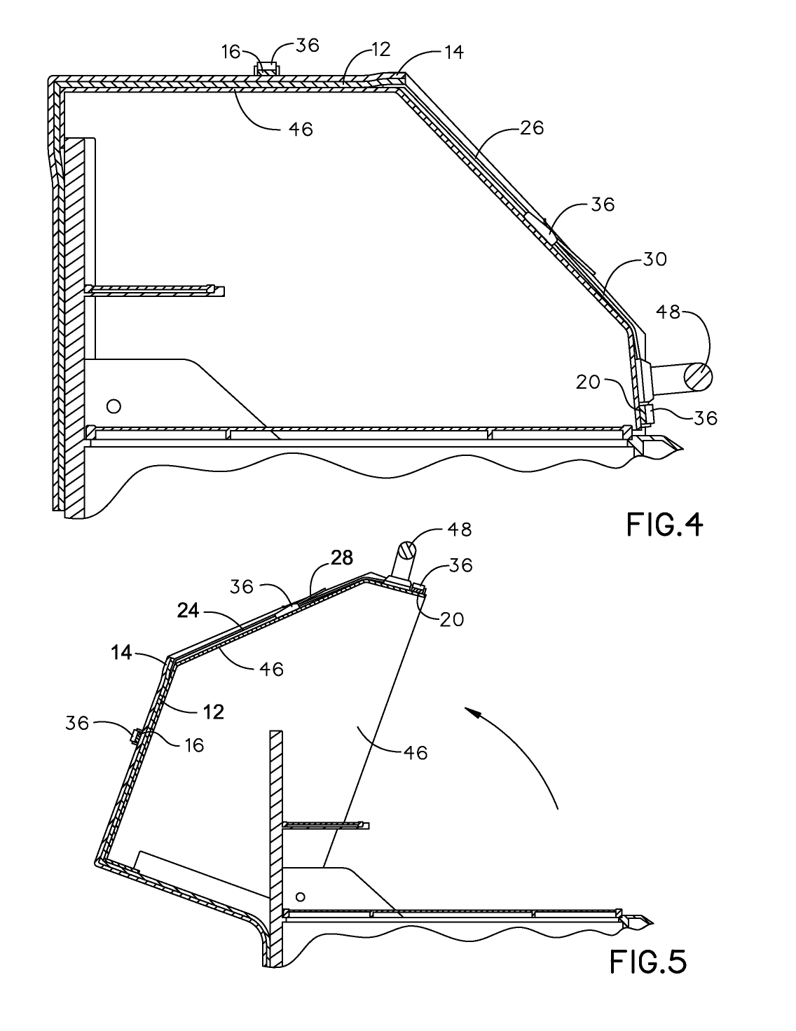

As is illustrated in FIGS. 1 through 5, a grill converter device 10 may include a plurality of cover sections, at least one airflow regulator cover 40 and at least one airflow regulator hole 38. In certain embodiments, the plurality of cover sections may include a first cover section 12 and a second cover section 14. The first cover section 12 and the second cover section 14 may be removably connected by a plurality of fasteners. The first cover section 12 may have a shape that may cover a portion of a grill lid 46. The second cover section 14 may have a shape that may cover another portion of the grill lid 46. Fasteners, such as straps and buckles 36, may removably secure the first cover section 12 to the second cover section 14. In certain embodiments, a first upper strap 16 may connect with a second upper strap 18 with a buckle 36. In certain embodiments, a first front strap 28 and a second front strap 30 may be disposed proximate a front side of a grill 50. A first loop 32 may be attached to the first front strap 28. A second loop 34 may be attached to the second front strap 30. A first lower strap 20 and a second lower strap 22 may slide into the first loop 32 and the second loop 34 respectively. The first lower strap 20 and the second lower strap 22 may then connect with a buckle 36. In certain embodiments, the first lower strap 20 and the second lower strap 22 may be placed below a grill lid handle 48. In certain embodiments, a first side strap 24 may connect with the first front strap 28 with a buckle 36. In certain embodiments, a second side strap 26 may connect with the second front strap 30 with a buckle 36. The straps, that may be adjustable, and the first cover section 12 and the second cover section 14, may allow for the device 10 to be placed on most models of grills 50. The first cover section 12 and the second cover section 14 may fold down flat to be stored in a drawer or the like.

In certain embodiments, the at least one airflow regulator hole 38 may be on at least one side of the plurality of cover sections. The airflow regulator hole 38 may be adjustably covered by the airflow regulator cover 40. The airflow regulator cover 40 may be adjusted to expose the airflow regulator hole 38 in varying degrees from a fully closed position through to a fully open position and any position in between. The at least one airflow regulator cover 40 may be removably attached to approximately just outside of the at least one airflow regulator hole 38 by fasteners such as hooked fastener strips 42 and looped fastener strips 44, and the like.

A method of using the present invention may include the following. A user may place the device 10 on a grill 50, such as a gas grill or the like. The user may then tighten all the fasteners so that the device 10 may wrap, or grip the grill lid 46. The device 10 may be made from fireproof/fire retardant material for the airflow regulator cover 40, the first cover section 12 and the second cover section 14. The straps may also be made from fireproof/fire retardant material. The smoking process may include having a box filled with water soaked wood chips that may be placed directly over an open flame set on a lowest setting. During the smoking process, the user may adjust the opening from the at least one airflow regulator hole 38 by moving the at least one airflow regulator cover 40 in conjunction with a burner control temperature as needed.

It should be understood, of course, that the foregoing relates to exemplary embodiments of the invention and that modifications may be made without departing from the spirit and scope of the invention as set forth in the following claims.

What is claimed is:

1. A grill converter device comprising:
a plurality of cover sections, wherein each cover section is removably connected to each other cover section by a plurality of fasteners;
at least one airflow regulator hole positioned along a side of at least one of the plurality of cover sections; and
at least one airflow regulator cover, wherein the at least one airflow regulator hole is removably covered by the at least one airflow regulator cover.

2. The grill converter device of claim 1, wherein the plurality of cover sections comprises a first cover section and a second cover section.

3. The grill converter device of claim 1, wherein the fasteners are adjustable.

4. The grill converter device of claim 3, wherein the fasteners are straps connected by buckles.

5. A method for converting a grill to a smoker configuration comprising:
placing a grill converter device on a lid of the grill, wherein the grill converter device comprises a plurality of cover sections, wherein each cover section is removably connected to each other cover section by a plurality of fasteners; at least one airflow regulator hole positioned along a side of at least one of the plurality of cover sections; and at least one airflow regulator cover, wherein the at least one airflow regulator hole is removably covered by the at least one airflow regulator cover;
tightening all fasteners to secure the grill converter device to the lid;
placing a smoke box directly over an open flame set on a lowest setting; and
adjusting the airflow regulator cover in conjunction with a burner control temperature as needed.

6. The method of claim 5, wherein the plurality of cover sections comprises a first cover section and a second cover section.

7. The method of claim 5, wherein the fasteners are straps connected by buckles.
